(19) United States
(12) Patent Application Publication
(10) Pub. No.: US 2020/0045564 A1
(43) Pub. Date: Feb. 6, 2020

(54) Centralized Controller for Nomadic Mobile Relay Network Elements

(71) Applicants: Jungnam YUN, Redmond, WA (US); Eamonn GORMLEY, Redmond, WA (US); Nokia Solutions and Networks Oy, Espoo (FI)

(72) Inventors: Jungnam Yun, Redmond, WA (US); Eamonn Gormley, Redmond, WA (US)

(21) Appl. No.: 16/482,090

(22) PCT Filed: Jan. 31, 2017
(86) PCT No.: PCT/US2017/015778

§ 371 Date: Jul. 30, 2019

(51) Int. Cl. H04W 24/02; H04B 7/155; H04W 72/08

(52) U.S. Cl. CPC H04W 24/02; H04W 88/04; H04W 72/085; H04B 7/15528

(57) ABSTRACT

A method performed by a centralized controller in a wireless communications network, the method including identifying at least one mobile relay network element in a coverage area of the network, communicating with the at least one mobile relay network element, and dynamically adjusting at least one radio parameter of a corresponding one of the at least one mobile relay network element in response to a predetermined event.

### FIELD OF TECHNOLOGY

This disclosure relates generally to the field of wireless communication networks, and more particularly to management of nomadic mobile relay network elements in wireless communication networks.

### BACKGROUND

Due to the rapid growth of consumer demands for increased wireless broadband data rates, telecommunication operators have started evolving their networks to heterogeneous networks (HetNets), which include macro cells and small cells configured to offload traffic from the macro cells. Similar to macro cells, small cells require a connection back to a core network to carry traffic to/from connected mobile devices and the core network. This connection is known as the backhaul connection. The backhaul connection may be a wireline connection (e.g., Copper wiring, Fiber Optic) or a wireless connection.

When small cells are deployed and managed by operators in a fixed location, KPIs are available in most instances and radio configuration parameters can be effectively optimized. However, nomadic mobile relays operated by end users are not always deployed in fixed locations, and therefore long-term collection of KPIs by the cells may not be effective or accurate. Further, it can be difficult to manage such nomadic mobile relay network elements.

### SUMMARY

A method performed by a centralized controller in a wireless communications network includes identifying at least one mobile relay network element in a coverage area of the network, communicating with the at least one mobile relay network element, and dynamically adjusting at least one radio parameter of a corresponding one of the at least one mobile relay network element in response to a predetermined event.

An apparatus in a wireless communication network includes a memory, and a processor in communication with the memory, wherein the processor is configured to communicate with at least one mobile relay network element, and dynamically adjust at least one radio parameter of the corresponding mobile relay network element in response to a predetermined event.

A system includes at least one user equipment, at least one mobile relay network element, and a centralized controller having a memory and a processor, wherein the processor is configured to communicate with the at least one mobile relay network element, and dynamically adjust at least one radio parameter of the corresponding mobile relay network element in response to a predetermined event.

### DESCRIPTION OF THE SEVERAL VIEWS OF THE DRAWINGS

To aid in the proper understanding of the present disclosure, reference should be made to the accompanying drawings, wherein:

FIG. 1 illustrates a mobile relay network element in accordance with the present application;

FIG. 2 illustrates a wireless network including a centralized controller in accordance with the present application;

FIG. 3 is a diagram of a centralized controller in accordance with the present application;

FIG. 4 is a diagram of interaction between the centralized controller and mobile relay network elements; and

FIG. 5 is a flow chart illustrating a method in accordance with the present application.

### DETAILED DESCRIPTION

The present disclosure provides, among other things, a centralized controller, also referred to herein as a Mobile Relay Controller or MRC. As will be described in further detail below, the MRC is configured to provide dynamic adjustment of radio parameters for each mobile relay network element in a communication network. As known in the art, mobile relay network elements are configured with cellular wireless backhaul for providing small area radio access to nearby end mobile users. Mobile relay network elements can also be configured to change their locations to, for example, minimize the total energy consumed by wireless transmissions.

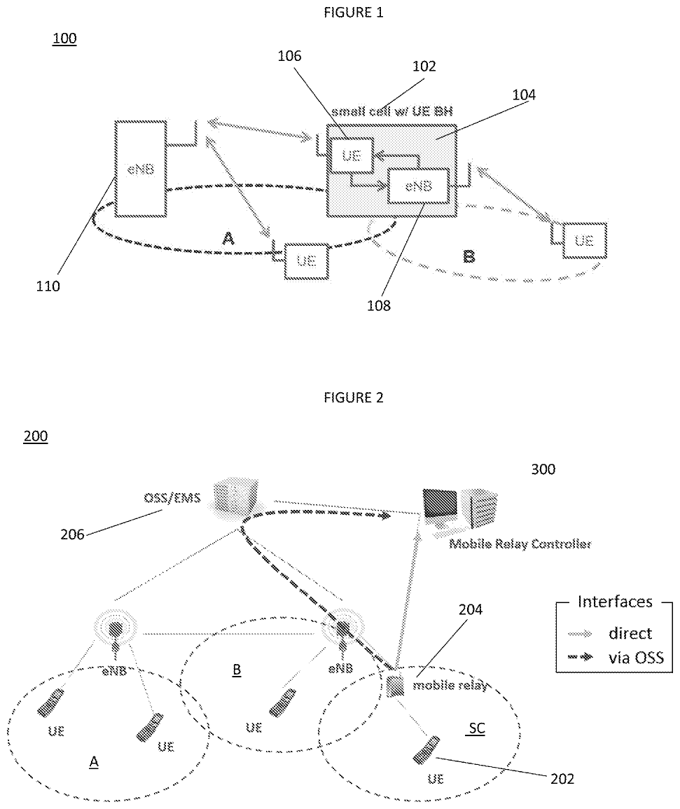

Turning to FIG. 1, a heterogeneous network 100 is depicted, and includes macro cells A and B, and a small cell 102. A mobile relay network element (also referred to herein as a “mobile relay”) 104 is provided in the small cell 102 and can be used as the wireless backhaul via an embedded UE 106 in the small cell. The mobile relay network element 104 can also include an embedded access part or eNB 108. The mobile relay network element 104 is nomadic in nature, and as such, is not deployed in fixed locations. Accordingly, the mobile relay 104 can optionally include a GPS receiver or other location-based device so it can accurately determine its location, which can later be retrieved by the MRC, as will be described in further detail below. Because of its nomadic nature, long-term KPIs collected and accumulated by the cells A and B, for example, may not be relevant to the current radio environment of the mobile relay network element 104.

To address this issue, a centralized Mobile Relay Controller (MRC) 300 is provided in a communication system or network 200, as shown in FIG. 2. The network 200 can be a heterogeneous network similar to that depicted in FIG. 1, and can include, for example, both macro cells “A” and “B” (shown with at least one UE in direct communication with a corresponding eNB) and at least one small cell “SC”. Specifically, in FIG. 2, at least one UE 202 is in communication with a mobile relay network element 204 (herein also referred to as “mobile relay”) in the small cell of the network 200. Although a single mobile relay 204 is shown in FIG. 2, it is to be understood that multiple mobile relay network elements may be present in the network 200.

As will be described in further detail below, the MRC 300 is configured to communicate with the mobile relay network element 204 via either a direct interface or a mobile relay network element management system, such as an OSS/EMS 206. In the direct interface scenario, depicted in FIG. 2 by a solid line (used to depict a logical interface), the MRC 300 communicates directly with the mobile relay network element 204. Specifically, in the direct interface scenario, the MRC 300 queries the mobile relay network element 204 directly for information, instead of retrieving the information from the OSS/EMS 206. This allows the MRC 300 to communicate with the mobile relay network element 204 via an eNB 110 of Cell A, for example. In this scenario, the eNB 110 still provides the wireless interface to the mobile relay network element 204. The direct interfaces may be used, for example, to report data or to enable the MRC 300 to dynamically adjust radio parameters at the mobile relay 204. Direct interfaces may be useful for fast reactions to changes in the radio environment of the network (i.e., location information, current transmit power, downlink and uplink center frequency, and allowed PRB groups). In the OSS scenario, depicted in FIG. 2 by a dashed line, the MRC 300 communicates directly with the OSS 206, which is then responsible for interacting with the mobile relay network element 204. The same information that is available via direct interface is also available via OSS. The interface via OSS may be a conventional northbound interface that provides access to CM (configuration management) data, PM (performance management) data, and other management information, as known in the art.

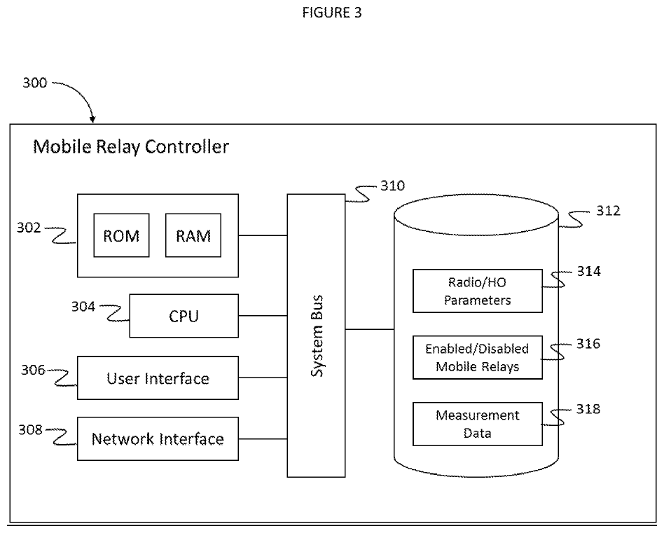

FIG. 3 depicts the centralized MRC 300, which can include, among other things, a memory 302 and a processor 304 in communication with the memory. The processor 304 is responsible for executing computer programs stored on volatile (RAM) and nonvolatile (ROM) memories 302 and a storage device 312 (e.g., HDD or SSD). The storage device 312 may store program instructions as logic hardware such as an ASIC or FPGA. Storage device 312 may store, for example, Handover or Radio Parameters 314, enabled/disabled mobile relays 316, and signal strength measurement data 318. The MRC 300 may also include a user interface 306 that allows an administrator to interact with the MRC's software and hardware resources and to display the performance and operation of the system 100. In addition, the MRC 300 may include a network interface 308 for communicating with other components in the networked computer system, and a system bus 310 that facilitates data communications between the hardware resources of the MRC 300. The MRC 300 can be a centralized processor located in a Self-Organizing Network, for example. As will be described in further detail below, the MRC 300, via the processor 304, is configured to communicate with at least one mobile relay network element 204, and to dynamically adjust at least one radio parameter of the corresponding mobile relay network element in response to a predetermined event. While not an exhaustive list, the radio parameter could be a cell individual offset (CIO), a qOffset, a physical cell identifier, a PRACH configuration, and/or a transmit power. The parameter could also be, for example, whether the mobile relay network element 204 is enabled or disabled.

Specifically, the processor 304 is configured to continuously monitor the network 200 and wait for a predetermined event that triggers dynamic adjustment of radio parameters in the network. For example, the predetermined event that triggers dynamic adjustment of radio parameters can include: a newly turned on mobile relay 204, a turned “off” mobile relay, detection of movement at the mobile relay, and detection of KPI values above/below predefined threshold values. If the predetermined event is detection of the KPI values being “above” a predefined threshold, the MRC 300 is configured to further investigate if any of the above-identified radio parameters can be further optimized to enhance performance of the network. If it is determined that such further optimization would result in an enhanced network, the MRC is configured to adjust the appropriate radio parameters such as, CIO, qOffset, or transmit power, so that UEs can be served by better mobile relay or macro cell that can provide higher throughput. Adjustment of radio parameters is known and is further described in commonly owned pending application WO/2016/206964, which is herein incorporated by reference.

To enable monitoring of the mobile relays 204, the MRC 300 is further configured to group mobile relay network elements into at least one cluster based on at least one of UE measurement and sniffer measurement. It is contemplated that by creating clusters (i.e., mobile relays that provide overlapping coverage) of mobile relays 204 based on UE measurement and/or sniffer measurement, the performance of each cluster is optimized. For example, mobile relays 204 with UE measurements within a certain threshold can be grouped into a cluster. The MRC 300 is further configured to add additional mobile relay network elements 204 to a corresponding one of the clusters when necessary and appropriate. For example, if the MRC determines that a UE is receiving a signal from a neighbor mobile relay element with higher signal strength than a predetermined threshold or higher signal strength than the signal strength from its source mobile relay that is already part of a group “A”, then the MRC can add the neighbor mobile relay to the group “A”. Similarly, mobile relays can be removed from the group “A” if it determines that their signal strength to serving UE is less than a predetermined threshold. When a mobile relay is removed from its cluster/group, that cluster is further investigated by the MRC 300 to determine whether the cluster is split into two (or more) separate clusters based on UE measurement. If the cluster is split, each new cluster or group is separately managed by the MRC.

The MRC 300 is further configured to add new mobile relay network elements to existing clusters upon detection of a newly turned on mobile relay. Specifically, when the MRC 300 detects that a new mobile relay has been turned “on”, it identifies nearby mobile relay network elements and adds the newly turned on mobile relay to the appropriate cluster. If there are no nearby existing clusters that are appropriate, then the MRC 300 can create a new cluster for the newly turned on mobile relay network element. If it is determined that the newly turned on mobile relay belongs to more than one cluster, then the MRC 300 can merge the clusters into a single cluster that includes the neighboring mobile relays and the newly turned on mobile relay. Similarly, when the MRC 300 detects a newly turned “off” mobile relay network element, it can remove the mobile relay from its corresponding cluster. As a result, the cluster may be separated to two clusters if the removed mobile relay network element had been bridging them.

In addition, the MRC 300 is configured to detect movement of the mobile relay network element 204, and in response to the detection of movement, remove the moving or nomadic mobile relay network from its corresponding cluster. Specifically, if movement is detected by the MRC 300, the eNB component (see reference number 108 in FIG. 1) may be turned off, depending on the operator's policy. The mobile relay 204 is then removed from its cluster. The backhaul/UE of the mobile relay 204 continues to report the mobile relay network element's location to the MRC 300, such that the MRC remains aware of its location and can turn it on and add it to the appropriate cluster once it is stationed at a set location.

The MRC 300 is further configured to disable the at least one mobile relay network element 204 based on at least one quality or radio parameter identified in the network 200. For example, the at least one quality parameter identified by the network can include a channel quality of the UE 202 connected to the at least one mobile relay network element 204. Specifically, if the UEs 202 connected to the mobile relay 204 have a better channel quality to the nearby macro cell “A” than a backhaul link quality for the mobile relay, the MRC 300 can disable the mobile network relay element 204. When the mobile relay 204 is disabled, the MRC 300 can configure handover or reselection offsets in the network 200 so that the UE 202 can directly select macro cell “A”, rather than another mobile relay, which could have even lower backhaul link quality than the disabled mobile relay 204. This ensures that the UE's performance is not degraded compared to if it had remained connected to the mobile relay 204. Similarly, if the UE 202 has better channel quality to a neighboring mobile relay network element (not shown) than its channel quality to the macro cell “A”, and the neighbor mobile relay has a better backhaul link to the macro cell “A”, the MRC 300 can disable the current mobile relay 204 so that the connected UE 202 can re-select the neighbor mobile relay as its serving cell.

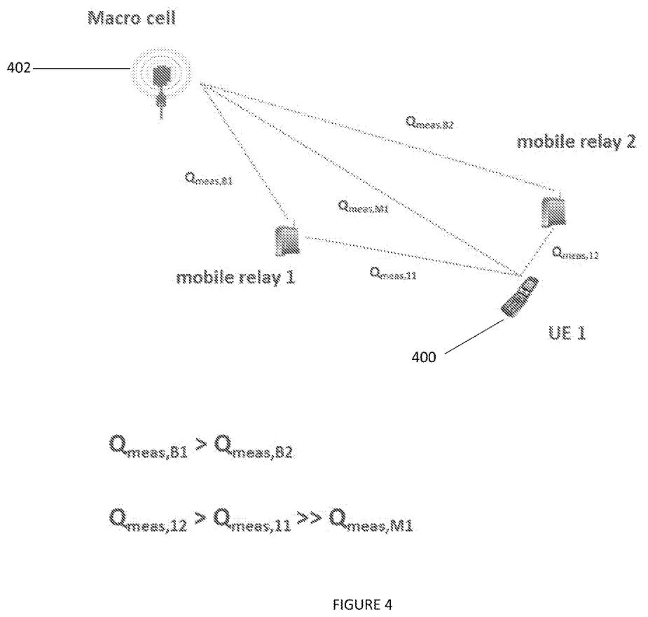

Another example scenario of interaction between the MRC and mobile relay network elements is shown in FIG. 4. In FIG. 4, UE 400 is connected to a macro cell 402, but mobile relay 1 and mobile relay 2 are also available for selection by the UE 400. Mobile relay 1, has better channel quality to the UE than the neighbor mobile relay 2. In this example, the MRC 300 considers three UE measurements: one for macrocell 402 (Qmeas,M1), and two for mobile relays 1 and 2 (Qmeas,11 and Qmeas,12, respectively). In FIG. 4, the UE 400 chooses mobile relay 2 as its serving cell because it is the highest value of Qmeas (Qmeas,12>Qmeas,11>>Qmeas,M1). However, the upper bound of throughput that the mobile relays 1 and 2 can provide is dependent on their backhaul radio link. Accordingly, it is better for the UE 400 to be served by mobile relay 1, because it has better backhaul link quality (Qmeas,B1>Qmeas,B2). In accordance with the present embodiment, the MRC 300 can update CIO/qOffset for those two mobile relay so that UE 400 can choose mobile relay 1 even when mobile relay 2 has better signal strength (Qmeas,12>Qmeas,11). Details on how to provide CIO/qOffset is addressed in commonly owned and co-pending application WO/2016/206964, which is herein incorporated by reference.

The MRC 300 is also configured to enable a previously disabled one of the at least one mobile network relay element 204 based on the at least one quality parameter. For example, if it is determined that the UE 202 can be better served by the mobile relay 204 than by the macro cell “A”, the MRC 300 can enable the previously disabled mobile relay 204 so that the UE can re-select the mobile relay 204 as its serving cell. Predetermined thresholds can be set for the at least one quality parameter (i.e., a minimum channel quality that must be met to enable a previously disabled mobile relay) by the operator, for example. Further, when determining whether to disable the mobile relay 204, the MRC 300 can further consider relative threshold (i.e., neighbor RSRP compared to serving RSRP) or absolute threshold in dBm (higher than a predetermined RSRP value).

When the MRC 300 decides to enable/disable the mobile relay 204, the cluster in which it was placed is further analyzed as well, to determine whether there have been changes at cells in the cluster with respect to channel quality, neighbor signal, and/or UE measurement, for example. The MRC 300 can then add/remove cells to/from the cluster as described above to ensure optimal performance of the cluster.

The MRC 300 can also be configured to determine whether the UE 202 is selecting the most appropriate mobile relay network element 204 as its server. For example, even if the MRC 300 determines that the RSRP from a neighbor mobile relay network element is lower than the RSRP from the serving/current mobile relay 204, if the backhaul link quality of the neighbor relay is better than that of the serving/current mobile relay 204, then the neighbor relay is actually the most appropriate server for the UE 202. Accordingly, the MRC 300 can change/adapt the radio parameter (i.e., qOffset) for each mobile relay network element 204, such that the UE 202 can automatically select the neighbor relay as its server, based on this updated radio parameter.

In addition, the MRC 300 can be configured to instruct the mobile relay 204 regarding its frequency channel/band segmentation or allowed physical resource blocks (PRB) so that interference between the mobile relay 204 and nearby mobile relays can be minimized. Specifically, a frequency channel can be assigned to each mobile relay 204. When the assigned frequency channel for the mobile relay 204 is larger than a minimum bandwidth defined by the network's specification, for example, the bandwidth for the mobile relay can be divided into smaller segments. Such division can prevent nearby/neighboring mobile relay network elements from strongly interfering with the mobile relay 204 when different segments are assigned to neighboring mobile relays. The MRC 300 may instruct the mobile relays of the allowed PRBs instead of frequency channels, so that the mobile relay keeps their frequency channel but uses non-overlapping radio resources between neighboring mobile relays. As a result, interference between the mobile relay 204 and neighboring mobile relays can be minimized.

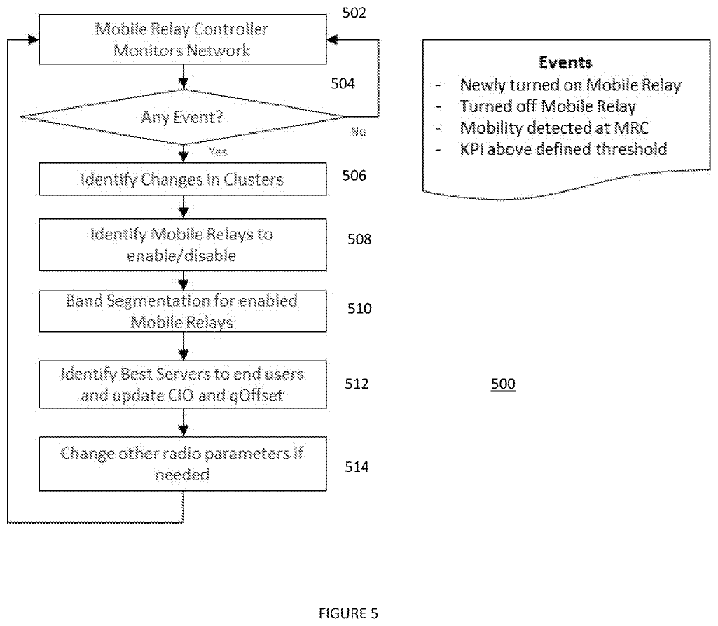

FIG. 5 illustrates a method 500 in accordance with the present disclosure. The method 500 is performed by the MRC 300, which includes, among other things, the memory 302 and the processor 304. At 502, the MRC 300 monitors the network and corresponding mobile relay network elements 204. The MRC 300 can be configured to communicate directly with the at least one mobile relay network element 204 or can be configured to communicate with the mobile relay network element via at least one of an Operations Support System (OSS) in the network or an Element Management System (EMS) in the network. At 504, the MRC 300 determines if a predetermined event has occurred in the network. As previously described, the predetermined event can include at least one of a recently turned on mobile relay network element, a recently turned-off mobile relay network element, detection of mobility of the mobile relay network element, and KPIs being above/below a predetermined threshold. If a predetermined event is not detected at 504, the method 500 proceeds back to step 502, where the MRC 300 continues to monitor and identify mobile relay network elements.

At 506, the MRC 300 is configured to identify changes in the clusters of mobile relay network elements 204, as previously described in detail above. For example, the MRC 300 can: identify whether new mobile relay network elements have been added to any of the clusters, identify whether clusters of the mobile relay network elements have been merged, and identify whether mobile relay network elements have been removed from any of the clusters. Specifically, the MRC 300 can add additional mobile relay network elements to a corresponding at least one cluster in response to detection of a newly turned on mobile relay network element. In addition, the MRC can be configured to detect movement of at least one of the one mobile relay network element. In response to the detection of movement, the MRC 300 can remove the at least one mobile relay network from its corresponding at least one cluster.

At 508, the MRC 300 can identify mobile relay network elements to enable/disable, as described above with respect to FIGS. 2-4. For example, the MRC 300 can disable a corresponding one of the at least one mobile network relay element when the channel quality is below a predetermined threshold and can enable a previously disabled one of the at least one mobile network relay element when the channel quality is above the predetermined threshold.

Next, at 510, the MRC 300 can perform band segmentation for enabled mobile relay network elements, as described above in detail with respect to FIGS. 2 and 3. At 512, the MRC 300 can identify the best servers for the UE based on, for example, the RSRP and backhaul link quality of the mobile relay network 204 compared to neighboring mobile relay networks, as previously described in detail with respect to FIGS. 2 and 3. As a result, the MRC 300 can also update radio parameters (i.e., CIO and qOffset). At 514, the MRC 300 can make any other radio parameter changes as needed. When all of the necessary radio parameters have been updated at 514, the method returns back to step 502.

The present mobile relay controller or MRC provides a centralized controller for monitoring and communicating with mobile relay network elements, and in particular, with nomadic mobile relay network elements. The MRC enables management of millions of mobile relays within a communications network, such as heterogeneous networks. The MRC is configured to cluster neighboring mobile relay elements and identify changes within the clusters, including but not limited to adding new mobile relay elements to clusters, disable mobile relay elements within the clusters, and merge/separate clusters as needed based on, for example, UE measurements. The MRC provides a robust and efficient method for management of nomadic mobile relay network elements.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional non-transitory computer-readable media. In the context of this document, a “non-transitory computer-readable medium” may be any media or means that can contain, store, communicate, propagate or transport the instructions for use by or in connection with an instruction execution system, apparatus, or device, such as a computer. A non-transitory computer-readable medium may comprise a computer-readable storage medium (e.g., memory or other device) that may be any media or means that can contain or store the instructions for use by or in connection with an instruction execution system, apparatus, or device, such as a computer. As such, the present invention includes a computer program product comprising a computer-readable storage medium bearing computer program code embodied therein for use with a computer, the computer program code comprising code for performing any of the methods and variations thereof as previously described. Further, the present invention also includes an apparatus which comprises one or more processors, and one or more memories including computer program code, wherein the one or more memories and the computer program code are configured, with the one or more processors, to cause the apparatus to perform any of the methods and variations thereof as previously described.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

One having ordinary skill in the art will readily understand that the invention as discussed above may be practiced with steps in a different order, and/or with hardware elements in configurations which are different than those which are disclosed.

The following abbreviations that may be found in the specification and/or the drawing figures are defined as follows:
CIO Cell Individual Offset
CM Configuration Management
EMS Element Management System
eNB eNodeB
GPS Global Positioning System
HetNet Heterogeneous Network
KPI Key Performance Indicator
MRC Mobile Relay Controller
OSS Operations Support System
PCI Physical Cell Identifier
PM Performance Management
PRACH Physical Random Access Channel
PRB Physical Resource Block
RSRP Reference Signal Received Power
UE User Equipment

1-20. (canceled)

21. A method performed by a centralized controller in a wireless communications network, the method comprising:
identifying at least one mobile relay network element in a coverage area of the network;
communicating with the at least one mobile relay network element; and
dynamically adjusting at least one radio parameter of a corresponding one of the at least one mobile relay network element in response to a predetermined event.

22. The method of claim 21 further comprising, at the centralized controller, grouping the at least one mobile relay network elements into at least one cluster based on at least one of UE measurement and sniffer measurement.

23. The method of claim 22 further comprising, at the centralized controller: adding additional mobile relay network elements to a corresponding at least one cluster in response to the predetermined event.

24. The method of claim 22 further comprising, at the centralized controller: detecting movement of at least one of the at least one mobile relay network element; and in response to the detection of movement, removing the at least one mobile relay network from its corresponding at least one cluster.

25. The method of claim 21 wherein the centralized controller is configured to communicate directly with the at least one mobile relay network element via at least one of an Operations Support System (OSS) in the network and an Element Management System (EMS) in the network.

26. The method of claim 21 wherein the predetermined event includes at least one of a recently turned on mobile relay network element, a recently turned-off mobile relay network element, detection of mobility of the mobile relay network element, and KPIs being above/below a predetermined threshold.

27. The method of claim 21 wherein the centralized controller is further configured to disable and enable the at least one mobile relay network element based on at least one quality parameter identified by the network.

28. The method of claim 25 wherein the at least one quality parameter identified by the network includes a channel quality of a UE connected to the at least one mobile relay network element.

29. The method of claim 26 further comprising:
at the centralized controller, disabling a corresponding one of the at least one mobile network relay element when the at least one quality parameter is below a predetermined threshold; and
at the centralized controller, enabling a previously disabled one of the at least one mobile network relay element when the at least one quality parameter is above the predetermined threshold.

30. An apparatus in a wireless communication network comprising:
a memory; and
a processor in communication with the memory, wherein the processor is configured to:
communicate with at least one mobile relay network element; and
dynamically adjust at least one radio parameter of the corresponding mobile relay network element in response to a predetermined event.

31. The apparatus of claim 30, wherein the processor is further configured to group the at least one mobile relay network elements into at least one cluster based on at least one of UE measurement and sniffer measurement.

32. The apparatus of claim 31, wherein the processor is further configured to add additional mobile relay network elements to a corresponding at least one cluster in response to the predetermined event.

33. The apparatus of claim 31, wherein the processor is further configured to detect movement of at least one of the at least one mobile relay network element; and in response to the detection of movement, removing the at least one mobile relay network from its corresponding at least one cluster.

34. The apparatus of claim 30 wherein the processor is further configured to disable and enable the at least one mobile relay network element based on at least one quality parameter identified the network;
wherein the at least one quality parameter identified by the network includes a channel quality of a UE connected to the at least one mobile relay network element.

35. A system comprising:
at least one user equipment;
at least one mobile relay network element; and
a centralized controller having a memory and a processor, wherein the processor is configured to:
communicate with the at least one mobile relay network element; and
dynamically adjust at least one radio parameter of the corresponding mobile relay network element in response to a predetermined event.
